(19) United States
(12) Patent Application Publication
(10) Pub. No.: US 2003/0017822 A1
(43) Pub. Date: Jan. 23, 2003

(54) Method and network arrangement for accessing protected resources using a mobile radio terminal

(76) Inventors: Martin Kissner, Kremmen (DE); Ralf Rammig, Muenchen (DE)

Correspondence Address: Morrison & Foerster LLP, Suite 300, 1650 Tysons Boulevard, McLean, VA, 22102, US

(21) Appl. No.: 10/187,444

(22) Filed: Jul. 2, 2002

(30) Foreign Application Priority Data
Jul. 2, 2001 (DE) 10132333.6

(51) Int. Cl. H04M 1/66; H04M 1/68; H04M 3/16; H04M 11/10; H04Q 7/20

(52) U.S. Cl. 455/411; 455/412; 455/433

(57) ABSTRACT

A system and method for accessing protected datasets or other resources in an IP network or on a content server using a mobile radio terminal over a mobile radio network, where in response to an access attempt, an authorization list stored in an authentication database is accessed in order to perform an authorization check on the basis of an identifier, particularly of the call number, over an intelligent network linked to the mobile radio network, and access is enabled or blocked on the basis of the result of the check.

### CLAIM FOR PRIORITY

This application claims priority from German application 10132333.6 filed Jul. 2, 2001.

### TECHNICAL FIELD OF THE INVENTION

The invention relates to a method for accessing protected resources in an IP network and to a corresponding network arrangement.

### BACKGROUND OF THE INVENTION

The Internet traditionally offers a confusing wealth of services, information and communication options which are open to any connected user free of charge and without special authorization or authentication. This largely free accessibility has made a substantial contribution to the rapid growth of importance of this data and communication network and to the explosive increase in the number of users thereof. From the outset, however, the Internet also had information sources which were not open to everyone but rather which could be accessed only on the basis of specific authorization. Recently, the number of such information services and other services to which access is limited and/or which can be accessed only in return for payment has increased in conjunction with the increasing commercialization and overall economic significance of the Internet.

For IP networks in firms and state or social facilities (Intranets), it is in fact normal practice to grant access at least to particular datasets and communication channels on the basis of particular authorizations.

It is a long-known practice to handle access authorizations in the form of passwords, PINs or other codes which are assigned to the authorized user and are stored in a checking facility in the system which performs an authentication check when access is attempted. It is also long-known practice—particularly in the field of banking—to use magnetic cards or smart cards as means for proving access authorization. Finally, the use of physiometric features (fingerprint, retinal image) has also gradually established itself in recent years for proving the identity of a person wishing to access protected datasets or services in a data network.

As is known, these established options are either relatively complex for the user—for example because he needs to remember a large number of different PINs or passwords or needs to carry around a relatively large number of access cards for various systems which he is authorized to access—and/or their use presupposes the presence of special, relatively complex readers. The latter drawback, which was not able to prevent the widespread implementation of card access systems for professional applications because the hardware involved is distributed over a very wide circle of users in this case, is a considerable obstacle for private use. It applies not only to card access systems but naturally also to systems which are based on the detection and evaluation of physiometric features of the user.

For mass applications, attempts are therefore increasingly being made to manage with the simplest and least complex access control systems possible which firstly do not require the user to input an authorization code and secondly do not require special reading or detection devices on the user's terminal. Besides systems which require “genuine” login—such as telnet, ftp or POP3—access control systems which merely check an identifier for the terminal used by the subscriber are therefore becoming established more and more. Such procedures are also used as additional security measures for the known login-based systems. These include ISDN Dial-In, where an (additional) identity check is performed on the basis of the call number of the ISDN line from which the protected system is accessed.

With the massive (now almost universal in industrial states) spread of mobile telecommunication, the mobile radio terminal is becoming more and more important as a means for accessing IP networks. The developments and relationships outlined above therefore require the implementation of convenient and inexpensive access control systems for resources in IP networks within the bounds of the mobile radio networks as well. In this context, however, there is a fundamental problem in the cellular design in connection with the freely selectable (in terms of network coverage) access location for the individual mobile radio terminal.

### SUMMARY OF THE INVENTION

The invention discloses a method and a network arrangement which provide a simple and inexpensive way for the user to access protected datasets or other resources on the basis of particular access authorizations.

In one embodiment of the invention, access is permitted to protected resources in an IP network from a mobile radio terminal without specific, case-by-case authentication by the user. Authentication also occurs on the basis of the terminal's MSISDN (Mobile Station International ISDN Number). The MSISDN or the associated authorization code form the basis of the access control.

The mobile radio terminal's identifier ascertained during the access attempt by an intelligent network positioned in the region of the network gateway between mobile radio network and IP network is compared with the identifiers stored in an authentication database. As the result of this authorization check, access to the desired resource is enabled or blocked.

The aforementioned authorization check is performed, in one embodiment, by an IN server in connection with the mobile radio network's home location database HLR (known per se from all mobile radio networks), which stores the MSISDN for registered terminals. The aforementioned authentication database comprises, in memory areas respectively associated with particular resources of the IP network which is to be protected, subsets of the MSISDN for the terminals of the subscribers authorized to access the respective resource, and possibly other codes and details.

The use of the invention is possible and appropriate to an entirely considerable extent in current mobile radio networks based on the GSM standard, in which information can be requested from IP networks by appropriately equipped mobile radio terminals on the basis of the WAP (Wireless Application Protocol) standard. However, it is gaining much greater significance for establishing the GPRS (General Packet Radio Service) standard, in which the switched mobile radio link is replaced by a permanent, packet-switched connection, and data requests are possible with much broader scope and at higher speed.

In one embodiment, during an access attempt using a mobile radio terminal, the aforementioned IN server receives an access signal from an IP network server (Access Point). It then evaluates the connection data resulting upon connection setup, ascertains the identifier for the accessing terminal, and makes an identification and authentication code available in the IP network. Said code corresponds to current IP means (namely LDAP/Radius). An IP server which is addressed ascertains the authentication in the IP network.

In another embodiment, when a connection is set up from the terminal to the IP network, at a network link unit, a suitable data protocol context is established and an upstream switching center in the mobile radio network is used to transmit to the intelligent network a message informing the intelligent network about the valid dynamic IP address of the terminal setting up the connection. The context reveals to the IN system the dynamic IP address of the user requesting access. This address is valid so long as the context exists, and is therefore valid for requests to the IP network server (Application Server).

In the GPRS-standard implementation highlighted as being preferred above, a PDP (Packet Data Protocol) context is established specifically at the GGSN (Gateway GPRS Support Node), and the message to the IN is transmitted via the SGSN (Serving GPRS Support Node) in the GPRS system. In the switching center, a trigger for initiating notification of the IN about setup of the data protocol context has been set in advance. In the implementation for a GSM system, the GGSN is replaced by a router or gateway in the GSM system, and the function of the SGSN is performed by the MSC (Mobile Switching Center).

To implement this sequence, in one embodiment, there is a CAMEL phase 3 interface (known as such) between the mobile switching center (the SGSN) and the intelligent network.

The proposed solution allows data access to Web pages or WAP pages, for example, to be effected securely but transparently—i.e. these pages can be addressed like public pages, but can be accessed by authorized users. Services which use an explicit login (such as the aforementioned telnet, ftp and POP3) can additionally be protected by the proposed method. When using a PC (laptop, PDA etc.) in connection with a mobile radio terminal as a client, it is also possible to implement file access, E-mail and the rest of the established information and communication options of IP networks within the context of the invention with access control.

In connection with the invention, besides the aforementioned additional protection for login-based systems it is also possible to alter the logic of the server process on the IP network server (Application Server) such that these services also no longer require explicit login. An intermediate. step involves the intended check on the access authorization for an IP connection on the application server being modified such that the IN server undertakes the authentication or checking of the access authorization.

In one aspect of the invention, the latter permits the implementation of joint access authorizations for user groups using mobile radio terminals for accessing selected resources (for example resources required for a joint project) in an IP network. In this context, a specific VPN service (VPN=Virtual Private Network) defines a user group for the purpose of a call number scheme or set of MSISDN for the mobile radio terminals used.

The authentication and authorization is performed using the terminal's subscriber identification (SIM, MSISDN), which means that the security standards of public landline networks are achieved without the need for an additional login.

On the basis of the access authorization assigned to the group, the members of the user group—which additionally has an SMS/Mailbox created for it, in particular—can each make individual use of the available data sources (in particular, can access a shared file server from a terminal with a data capability) and can send SMS or E-mails to the other members of the group.

Like the proposed solution overall, the embodiment being discussed at present can—with certain restrictions—also be used within the context of the GSM/WAP system, which means that, by way of example, it is possible to access WML pages on a WAP file server as a result of authorization by group access authorization. The implementation within the context of the GPRS system is preferred in this case too, with HTML pages on an HTTP file server then also being able to be requested.

Preferably, a separate subscriber account (Account) is set up and a subscriber identifier allocated for each group member. At least selected access operations within the area of the IP network which can be accessed on the basis of the joint access authorization can then be individually assigned to the subscriber accounts. This means that the resources used individually can be invoiced, if appropriate.

To the extent that no explicit reference has already been made to corresponding apparatus aspects—the aforementioned method aspects also have corresponding apparatus aspects in the proposed solution. These apparatus aspects are therefore not explained again in detail at this point.

### BRIEF DESCRIPTION OF THE DRAWINGS

Advantages and expediencies of the invention can be found in the subclaims and in the skeleton description below of two basic implementation options with reference to the figures, in which:

FIG. 1 shows an exemplary illustration for the authorization check during access to an IP network from a mobile radio terminal.

FIG. 2 shows an exemplary illustration of access to VPN-group-specific resources in an IP network.

### DETAILED DESCRIPTION OF THE INVENTION

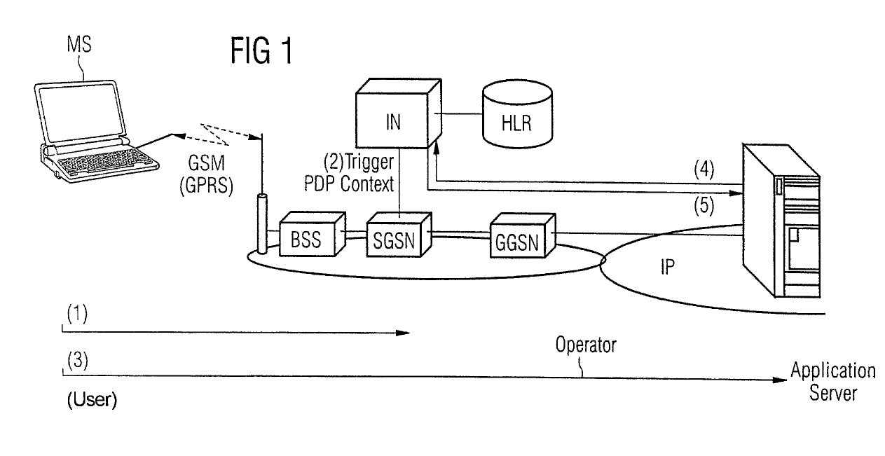

FIG. 1 is an example of how a user uses a mobile radio terminal (Communicator) MS with data capability to set up a connection to a GSM network based on the GPRS standard in (1), in order to be able to access resources on the Internet IP. During the connection setup for the IP channel from the terminal MS to the ACCESS POINT NAME in the GGSM, a PDP context is established. In (2), the SGSN informs the intelligent network IN about the new context on the basis of a previously set trigger. The context reveals the user's dynamic IP address to the intelligent network.

In (3), the IP access is switched through to the application server, and from there an authorization request or authentication request is passed to the intelligent network in (4). If the result of an authorization check which is then performed on a server in the intelligent network by accessing the HLR is that the user of the terminal MS has the authorization required for the requested resource, the application server is informed of this in (5) and the user is then granted the requested access—otherwise access is rejected.

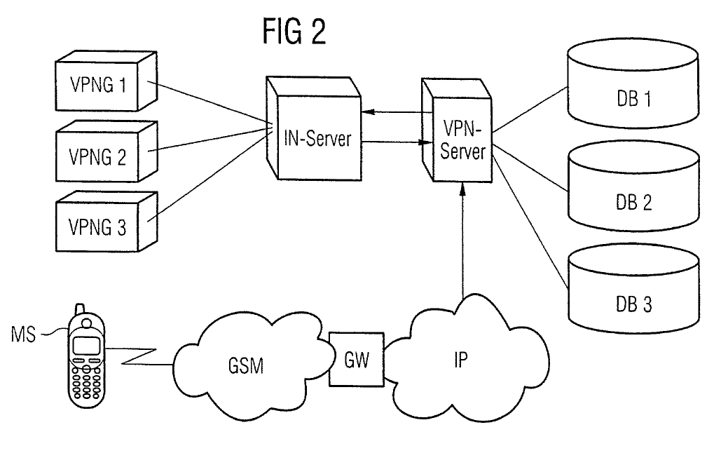

FIG. 2 shows an example of how a user uses a mobile telephone MS with GPRS capability to access an IP network IP via a mobile radio network GSM and a gateway GW using the GPRS standard, said IP network IP containing a WAP gateway/file server denoted as VPN server in the figure. The VPN-server can be used to access three resource groups DB1, DB2 and DB3.

The WAP gateway or the file server communicates with a server in an intelligent network IN server, which manages identification and authorization data for three user groups VPNG1, VPNG2 and VPNG3. The resources DB1 to DB3 are accessed using the mobile radio terminal without explicit login.

The user is known and authenticated from his MSISDN, and a special service entity for granting access with the necessary access rights is started between the IP network IP and the server VPN server. To this end, the VPN server initiates an authorization check on the IN server. The latter assigns the accessing subscriber to one of the VPN groups VPNG1 to VPNG3 on the basis of the MSISDN and sends a corresponding authorization code to the VPN server. The latter then process the request and, on the basis of the authorization code received, grants access to the required resource or rejects said access (if the user does not have the necessary group access authorization).

In this embodiment, the resources can preferably be chosen in line with the equipment standard of the terminal. If these are not known, they are communicated implicitly by the URL used. Every user who is on line in fact has his own server entity.

The embodiment of the invention is not limited to the examples and highlighted aspects described above, but is likewise possible in a large number of modifications which are within the scope of expert action.

What is claimed is:

1. A method for accessing protected datasets or other resources in an IP network or on a content server using a mobile radio terminal over a mobile radio network, comprising:
accessing an authorization list in an authentication database, in response to an access attempt, to perform an authorization check based on an identifier over an intelligent network linked to the mobile radio network, such that access is enabled or blocked based the result of the check.

2. The method as claimed in claim 1 wherein the authorization check is performed by an IN server in conjunction with a home location database for the mobile radio network.

3. The method as claimed in claim 1, wherein the authorization list in the authentication database includes an MSISDN for the mobile radio terminals registered in the mobile radio network.

4. The method as claimed in claim 1, wherein the mobile radio network is operated based on the GPRS, GSM/WAP or UMTS standard.

5. The method as claimed in claim 2, wherein the IN server receives an access signal from an IP network server when there is an access attempt and, if the result of the check is positive, sends to the IP network server an identification and/or authentication code which represents a defined access authorization for selected resources.

6. The method as claimed claim 1, wherein when a connection is set up from the mobile radio terminal to the IP network, at a network link unit, a data protocol context is established and an upstream switching center is used to transmit a corresponding message to the intelligent network, and the intelligent network is informed about the valid dynamic IP address of the mobile radio terminal.

7. The method as claimed in claim 6, wherein a trigger to notify the intelligent network about set up of the data protocol context is set in the switching center in advance.

8. The method as claimed in claim 6, wherein the message is transmitted from the SGSN to the intelligent network via a CAMEL Phase 3 interface.

9. The method as claimed in claim 1, wherein the protected resources are Web or WAP pages.

10. The method as claimed in claim 1, including use for the protection of the resources of a login-protected service.

11. The method as claimed in claim 1, wherein a defined group of users of the mobile radio network is assigned a joint access authorization represented by a group identifier.

12. The method as claimed in claim 11, wherein the joint access authorization is used to grant the users in the group access to an HTTP or WAP file server which manages datasets and/or other resources.

13. The method as claimed in claim 12, wherein the datasets on the file server are in the form of HTML or WML pages, and/or the message stores are in the form of mailboxes or voice mailboxes.

14. The method as claimed in claim 11, wherein for each subscriber in the group a subscriber account is set up and a subscriber identifier is allocated, and at least selected access operations to datasets or to other resources are assigned to the subscriber account using the subscriber identifier.

15. A network having a mobile radio network and an IP network or content server linked thereto, comprising:
an authentication database for storing an authorization list of access authorizations for subscribers in the mobile radio network to the IP network or content server, and to an intelligent network for performing an authorization check based on an identifier for an accessing mobile radio terminal and by accessing the authentication database, and for enabling or blocking access based on the result of the check.

16. The network as claimed in claim 15, wherein the intelligent network has an IN server which cooperates with a home location database for the mobile radio network.

17. The network as claimed in claim 15, wherein the mobile radio network is a network based on the GPRS, GSM/WAP or UMTS standard.

18. The network as claimed in claim 15, further includes a device for establishing a data protocol context at a network link unit between the mobile radio network and the IP network.

19. The network as claimed in claim 15, having a CAMEL phase 3 interface between a switching center in the mobile radio network and the intelligent network or IN server.

20. The network as claimed in claim 15, wherein the intelligent network has an HTTP or WAP file server which manages datasets and/or message stores individually associated with subscribers in the mobile radio network and similar resources.

21. The network as claimed in claim 15, wherein the authentication database has at least one memory area for storing a joint access authorization for a group of subscribers in the mobile radio network or is configured to store an authorization list including at least one group of associated rows.
